(19) United States
(12) Patent Application Publication
(10) Pub. No.: US 2013/0314267 A1
(43) Pub. Date: Nov. 28, 2013

(54) MULTI-BAND SCANNING FOR RADAR DETECTION IN WI-FI SYSTEMS

(71) Applicants: THOMAS J. KENNEY, Portland, OR (US); ELDAD PERAHIA, Portland, OR (US)

(72) Inventors: THOMAS J. KENNEY, Portland, OR (US); ELDAD PERAHIA, Portland, OR (US)

(21) Appl. No.: 13/726,993

(22) Filed: Dec. 26, 2012

Related U.S. Application Data
(60) Provisional application No. 61/651,195, filed on May 24, 2012.

(51) Int. Cl. G01S 7/02

(52) U.S. Cl. CPC G01S 7/021
USPC 342/21

(57) ABSTRACT

Systems and methods are described herein for determining the presence of radar signals within the 5 GHz band using an active communications channel and a portion of the channels adjacent to the active channel. The access point radio may collect the bandwidth of the active and adjacent channels concurrently to avoid having to tune to each channel separately. Further, the radar scanning and a portion of the active channel processing may be completed simultaneously to improve access point utilization.

### CROSS REFERENCE TO RELATED APPLICATION

This application claims the benefit of U.S. Provisional Application No. 61/651,195 filed May 24, 2012, wherein the U.S. Provisional Application No. 61/651,195 is incorporated by reference into this application.

### TECHNICAL FIELD

This disclosure generally relates to systems and methods for operating wireless communications devices within the 5 GHz band, particularly, avoiding radar interference from the wireless communications devices operating within the 5 GHz band.

### BACKGROUND

As more Wi-Fi devices hit the market, there is a need to utilize more of the frequency bands that become available. Currently, Wi-Fi devices operate in either the 2.4 or 5 GHz or both bands depending on the given revision of the Institute of Electrical and Electronics Engineers (IEEE) 802.11 specification that may be used. Prior to the advent of 802.11n-compliant devices, nearly all devices operated solely in the 2.4 band. Even though 802.11a is specified for the 5 GHz band, its deployment prior to 802.11n rarely occurred. Within Wi-Fi, both Peer-to-Peer and Wi-Fi direct are becoming standard features on Wi-Fi devices. It is also becoming common that access points (APs) have the option of either 2.4 GHz or 5 GHz as operational bands, but increasingly many offer simultaneous operation in both bands. Thus, transition to 5 GHz band has begun.

### BRIEF DESCRIPTION OF THE FIGURES

The features within the drawings are numbered and are cross-referenced with the written description. Generally, the first numeral reflects the drawing number where the feature was first introduced, and the remaining numerals are intended to distinguish the feature from the other notated features within that drawing. However, if a feature is used across several drawings, the number used to identify the feature in the drawing where the feature first appeared will be used. Reference will now be made to the accompanying drawings, which are not necessarily drawn to scale and wherein:

FIG. 1 illustrates a system for detecting radar signals that may be impacted by wireless signals used in the operation of a wireless network in accordance with one or more embodiments of the disclosure.

FIG. 2 illustrates a schematic of the 5 GHz band used for wireless networks and the Dynamic Frequency Selection portion of the 5 GHz band in accordance with one or more embodiments of the disclosure.

FIG. 3 illustrates a schematic of the transmission spectrum mask for the 20 MHz active channel in accordance with one or more embodiments of the disclosure.

FIG. 4 illustrates a system for detecting radar signals in parallel with processing active channel signals of a wireless network in accordance with one or more embodiments of the disclosure.

FIG. 5 illustrates a flow diagram for another method for detecting radar signals in parallel with processing active channel signals of a wireless network in accordance with one or more embodiments of the disclosure.

### DETAILED DESCRIPTION

Embodiments of the disclosure are described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art.

This disclosure may describe systems, methods, and devices for analyzing an active channel bandwidth and a portion of an adjacent bandwidth for radar signals in the 5 GHz band while processing the active channel bandwidth at a substantially similar or same time.

The 5 GHz band offers many more channels than offered by the 2.4 GHz band. It is currently less congested, and has less interference from other devices (e.g., Bluetooth, microwave ovens, etc.). The larger bandwidths of 802.11ac further necessitated the standard to mandate operation in only the 5 GHz bands.

One drawback to the 5 GHz band pertains to requirements that devices operating or wishing to operate within that band not interfere with existing radar systems. For example, there are stringent FCC (Federal Communications Commission) requirements for operating in the (Dynamic Frequency Selection) DFS portion of the 5 GHz band. DFS is a mechanism to allow unlicensed devices to share spectrum with existing radar systems (one example are weather radars on or near airports).

The FCC requirements regarding use of the DFS bands require detection probabilities of any radar installations, which detection probabilities would necessitate long scan intervals. According to currently proposed solutions, a device (e.g., access point) using the 5 GHz band should scan channels sufficiently for a long enough time period to guarantee a certain confidence level that no radar is present.

Currently access points (APs) of a wireless network can be configured to operate in the DFS bands, and as the band becomes more congested, as is now the case for the 2.4 GHz band, operation in the DFS Bands could be a necessity. Additionally, in the near future, even client devices will start to have architectures that allow them to use the DFS bands in a Peer-to-Peer or Wi-Fi Direct mode, where they will also be required to meet the FCC scanning requirements.

For the DFS bands, the current FCC requirement for a DFS master device (e.g., an access point) to scan any channel prior to use, the detailed requirements of that scanning being omitted here for brevity. Once the device has found a “radar free” channel (one where radar is not detected), it can use the channel, but must constantly, at prescribed intervals, scan for radars while using the channel. The DFS portion of the 5 GHz band may include a first range of frequencies from 5.25 GHz to 5.35 Ghz and a second range of frequencies from 5.47 GHz to 5.725 GHz.

In certain instances, it may be desirable to scan not only the Wi-Fi channels (channels sought to be used to communicate Wi-Fi signals), but also to scan channels adjacent to the Wi-Fi channels for any potential or actual interference with radar systems. These instances, while providing a more robust technique to avoid interference with radar, could result in even longer scan times than instances where only the Wi-Fi channels are being scanned, but also potentially in reduced throughput during communication operations. To use Wi-Fi channels in bands associated with radar requires rigorous scanning in order to find channels where no radars are operating. Additionally, once a radar free channel is found during the initial scan, the device must periodically scan the channel it is operating on to verify that no radars are present.

In short, being able to scan for radar signals without having to tune to adjacent channels eliminates system throughput loss and reduces power consumption compared to having to scan the individual (e.g., adjacent) channels.

Example embodiments of the disclosure will now be described with reference to the accompanying figures.

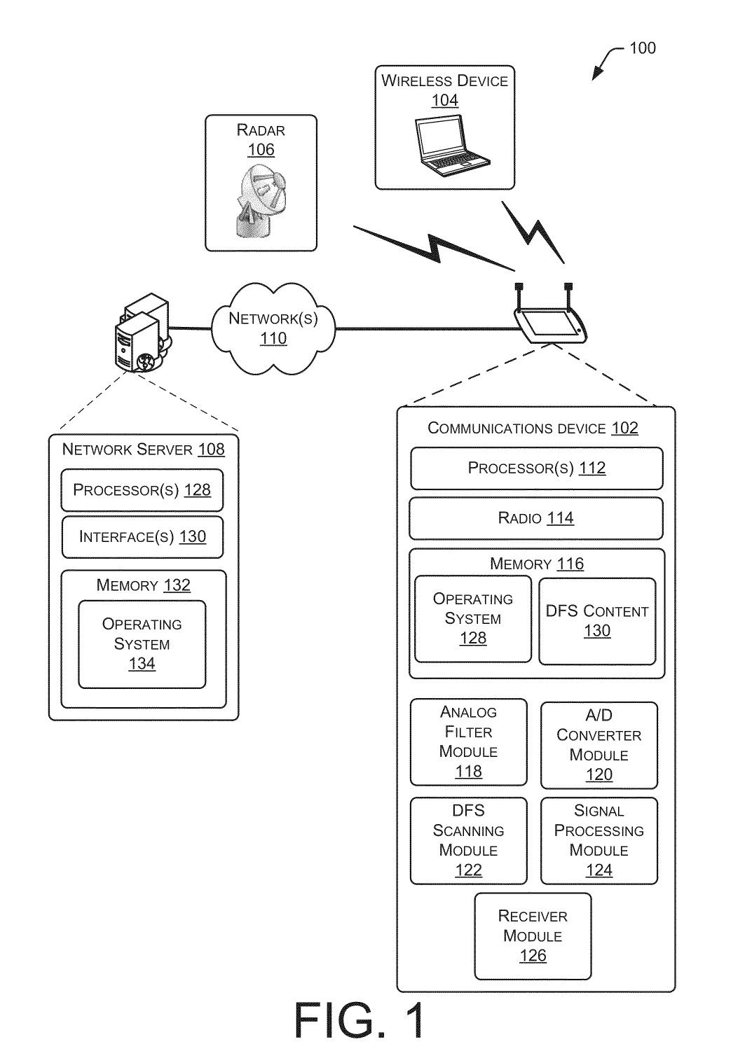

FIG. 1 illustrates a system for detecting radar signals that may be impacted by wireless signals used in the operation of a wireless network. The system may include a communications device 102 that may receive signals in the 2.4 GHz and 5 GHz bands. A wireless device 104 may provide signals in 2.4 GHz and 5 GHz bands and a radar system 106 may provide signals in the 5 GHz band. As noted above, the FCC mandates that the communications device 102 monitor for radar signals or signatures to prevent interfering with radar 106 operations. In one embodiment, the communications device 102 may also be in electrical communication with a network server 108 via a network 110.

The communications device 102 may include, but is not limited to: a wireless access point, wireless router, smartphones, mobile phones, laptop computer, desktop computer, tablet computers, televisions, set-top boxes, game consoles, in-vehicle computer systems, and so forth. In one specific embodiment, the communications device 102 may be a master device for a wireless network that communicates with client devices (e.g., wireless device 104). The communications device 102 may include, but is not limited to, one or more computer processors 118, a radio 114, memory 116, an analog filter module 118, an analog-to-digital (A/D) converter module 120, a DFS scanning module 122, a signal processing module 124, and a receiver module 126.

The computer processor 112 to execute computer-readable instructions stored in memory 116 that enable the communications device 102 to execute instructions on the hardware, applications, or services associated embedded on the communications device 102 (e.g., DFS scanning module 122, etc). The one or more computer processors 112 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. In certain embodiments, the computer processor may be based on an Intel® Architecture system and the processor(s) 112 and chipset may be from a family of Intel® processors and chipsets, such as the Intel® Atom® processor family. The one or more processors 112 may also include one or more application-specific integrated circuits (ASICs) or application-specific standard products (ASSPs) for handling specific data processing functions or tasks.

In certain embodiments, the communications device 102 may also include an Input/Output (I/O) interfaces (not shown) that enables a user to view content displayed by the device or to interact with the computer using various tactile responsive interfaces such as a keyboard, touch screen, or mouse.

The communications device 102 may also include a radio 114 that may transmit and receive wireless signals that may enable the communications device 102 to communicate wirelessly with the wireless device 104. In certain instances, the radio may also receive radar signals from the radar 106. The radio 114 may include the hardware and software to broadcast and receive messages either using the Wi-Fi Direct Standard (See; Wi-Fi Direct specification published in October 2010) and or the IEEE 802.11 wireless standard (See; IEEE 802.11-2012, published Mar. 29, 2012) or a combination thereof. The wireless system may include a transmitter and a receiver or a transceiver (not shown) capable of operating in a broad range of operating frequencies governed by the 802.11 wireless standard.

The memory 116 may include an operating system 128 to manage and execute applications stored therein as well as other systems and modules within the computer. The memory 116 may be comprised of one or more volatile and/or non-volatile memory devices including, but not limited to, random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read-only memory (EEPROM), non-volatile RAM (NVRAM), universal serial bus (USB) removable memory, or combinations thereof. The memory 116 may include, but is not limited to, a DFS content module 130 that may store the historical usage data of the radar signals or signatures that are detected by the communications device 102. The historical usage data may include, but is not limited to, time of detection, power, frequency, and/or location of the radar 106. The location of the radar may be determined, at least in part, by triangulating the location by using additional communications devices or access points in the wireless network.

In one embodiment, the communications device 102 may scan channels of interest, the scanning of a DFS channel taking approximately 60 seconds per channel. The scanning may be done to verify that there are no radar signals that the communications device 102 will interfere with over a set transmit power level. The exact power level may be as high as 30 dB below the maximum transmit power, but may also be as stringent as 45 dB down. A power threshold requirement of 30 dB may take at least 3 minutes to scan and a power threshold requirement of 45 dB may take on the order of 5 minutes. Additionally, once the communications device 102 is using the Wi-Fi channel or active channel the communications device 102 may also scan while it is using the active channel. Scanning an active channel while it is being used is not all that difficult since the receiver (Rx) chain is fixed to that frequency, but now the communications device 102 may have to tune to 2, or 4 other frequencies and scan while also operating on the active channel. This may mean scanned signals will be attenuated by virtue of the open Rx chain. The communications device 102 could attempt to do this during quiet periods (periods when there is no data traffic on the active channel it is using), but when more than one channel is to be scanned, and the receiver has to be tuned to other channels. However, it may be unlikely that this can be done without impact to the throughput on the active channel. In this instance, the device may have to halt communications to do a scan for radar signals or signatures.

In one embodiment, the communications device 102 may make use of the multi-rate capabilities of the radio 114 or a wireless device (e.g., 802.11ac compliant device). Such devices could support 20, 40, 80 and optionally 160 MHz bandwidths. Embodiments advocate a multi-stage front end for the device.

In one specific embodiment, for the purpose of explanation, the active channel may include a 20 MHz bandwidth channel in the DFS band. In other embodiments, the 40, 80 and optionally 160 MHz bandwidths may also be used as active channels. In this instance, assuming a power threshold requirement of 30 dB below, this may mean the receiver would have to scan to provide coverage out to approximately 10 MHz on each side of the Wi-Fi/active channel to be used. Instead of scanning the active channel and the two adjacent channels in series (which would take 3× the time) the receiver or radio 114 would have a front end that would be able to process a wide bandwidth. The wide bandwidth may include both the active channel and an excess bandwidth (e.g., adjacent channels) as defined by the power threshold, which in this case would be 50%. In this case, the communications device 102 may have a front end that would pass the 20 MHz active channel (WI-Fi channel) and 10 MHz on each adjacent side (excess bandwidth) for a total of 40 MHz.

The analog filter module 118 may filter the incoming signals to include the active channel and at least a portion of the channels adjacent to the active channel. The analog filter module may include a baseband filter that excludes the frequencies outside of the active channel and the adjacent channels. Each channel, including the active channel, may include subchannels. Each subchannel may have a bandwidth of 20 MHz. The active channel plus the adjacent channels (excess bandwidth) may have a total bandwidth of up to 40 MHz, 80 MHz, 160 MHz or larger.

The A/D converter module 120 may convert the active and adjacent bandwidth from an analog signal to a digital signal. The A/D sampling rate may be greater than or equal to the adjacent bandwidth to meet the FCC adjacent channel mask to verify that channels adjacent to the active channel do not have radar signals or signatures.

The DFS scanning module 122 or a radar scanning engine may scan for radar of a wide bandwidth including a bandwidth of the active channel plus the bandwidth of the adjacent channels (excess bandwidth) of the active channel. The DFS scanning module 122 may scan for radar in a Dynamic Frequency Selection (DFS) portion of the 5 GHz frequency band. The DFS portion may include the frequency ranges of 5.25 GHz to 5.35 Ghz and 5.47 GHz to 5.725 GHz.

The communications device 102 may further include a signal processing module 124 to process signals in the wide bandwidth by filtering out the signals in the adjacent bandwidth (excess bandwidth) to further process the signals in the active channel. For example, the signal processing module 124 may include a digital filter to remove the adjacent bandwidth to isolate the active bandwidth. The filtered active channel may also be downsampled to enable Wi-Fi channel processing.

The DFS scanning module 122 may be configured to scan for radar simultaneously with and/or prior to a processing of the signals in the wide bandwidth by the signal processing module 124.

The receiver module 126 may receive the active channel signal from the signal processing module 124 and the active and adjacent channel signal from the DFS scanning module 122. In certain instances, the DFS scanning module 122 may provide an indication of whether radar signal or signature was present in the active and adjacent channel signal.

The wireless device 104 may include, but is not limited to: a wireless access point, wireless router, smartphones, mobile phones, laptop computer, desktop computer, tablet computers, televisions, set-top boxes, game consoles, in-vehicle computer systems, and so forth. The wireless device may include a computer processor, memory, a wireless communications device, and/or other interface components that may enable the entering or display of information or content (not shown).

The radar 106 may include an antenna, a transmitter, and a receiver (not shown). The radar 106 may transmit and receive electromagnetic signals to monitor weather conditions, monitor aviation or marine traffic, and/or to implement military systems for air defense or command and control.

The network server 108 may provide information, content, or any electronic data over the network 108 to the communications device 102. The network server 108 may facilitate communication with other servers, network devices, and/or access points (not shown). The location server 106 may include, but is not limited to, one or more computer processors 128, interfaces 130, and memory 132.

The computer processors 128 may comprise one or more cores and are configured to access and execute (at least in part) computer-readable instructions stored in the one or more memories 132. The one or more computer processors 128 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The location server 106 may also include a chipset (not shown) for controlling communications between the one or more computer processors 128 and one or more of the other components of the location server 106. In certain embodiments, the network server 108 may be based on an Intel® architecture or an ARMO architecture and the computer processor(s) 128 and chipset may be from a family of Intel® processors and chipsets. The one or more computer processors 128 may also include one or more application-specific integrated circuits (ASICs) or application-specific standard products (ASSPs) for handling specific data processing functions or tasks.

The interfaces 130 may include coupling devices such as keyboards, joysticks, touch sensors, cameras, microphones, speakers, haptic output devices, memories, and so forth to the location server 106. The interfaces 130 may also comprise one or more communication interfaces or network interface devices to provide for the transfer of data between the communications device 102. The communication interfaces may include, but are not limited to: personal area networks (“PANs”), wired local area networks (“LANs”), wireless local area networks (“WLANs”), wireless phone networks, wireless wide area networks (“WWANs”), and so forth. In FIG. 1, the network server 108 is coupled to the network 110 via a wired connection, but a wireless connection may also be used. The wireless system interfaces (not shown) may include the hardware and software to send and receive messages either using the Wi-Fi Direct Standard (See; Wi-Fi Direct specification published in October 2010) and or the IEEE 802.11 wireless standard (See; IEEE 802.11-2012, published Mar. 29, 2012) or a combination thereof. The wireless system may include one or more transmitters and receivers or a transceiver (not shown) capable of operating in a broad range of operating frequencies governed by the IEEE 802.11 wireless standards or one or more of the following cellular standards: Global System for Mobile Communications (GSM™), Code Division Multiple Access (CDMA™), Universal Mobile Telecommunications System (UTMS™), Long Term Evolution (LTE™), General Packet Radio Service (GPRS™), High Speed Downlink Packet Access (HSDPA™), Evolution Data Optimized (EV-DO™). The communication interfaces may utilize acoustic, radio frequency, optical or other signals to exchange data between the network server 108 and the network 110.

The one or more memories 132 may comprise one or more computer-readable storage media (“CRSM”). In some embodiments, the one or more memories 132 may include: non-transitory media such as random access memory (“RAM”), flash RAM, magnetic media, optical media, solid state media, and so forth. The one or more memories 132 may be volatile (in that information is retained while providing power) or non-volatile (in that information is retained without providing power.) Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 132 may store an operating system 134 that includes a plurality of computer-executable instructions that may be implemented by the computer processor 128 to perform a variety of tasks to operate the interface(s) 130 and any other hardware installed on the network server 108.

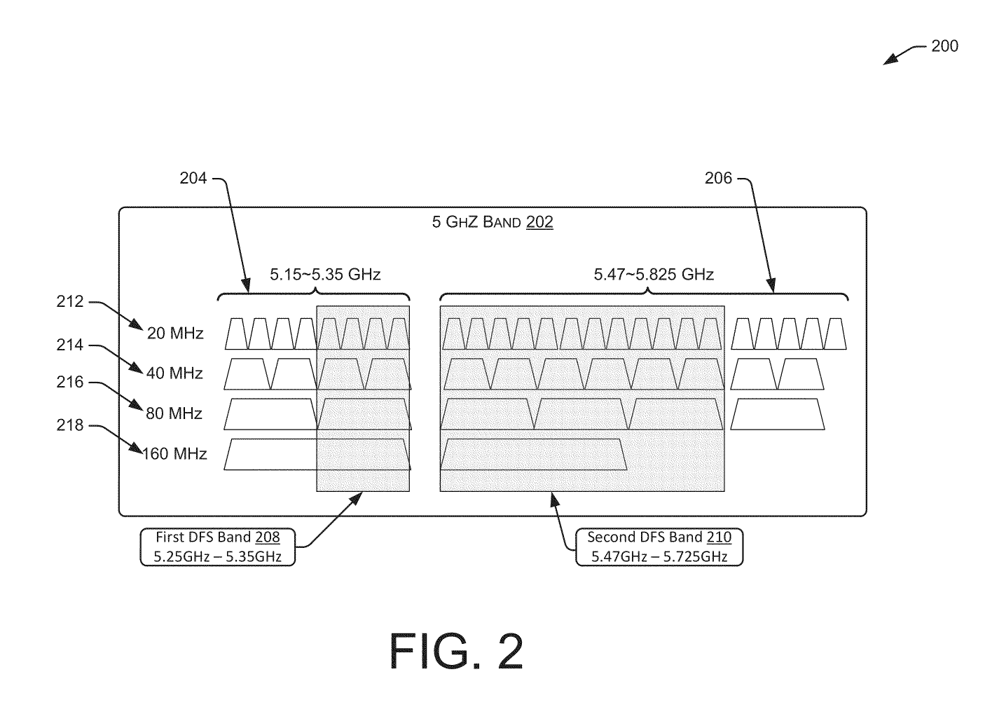

FIG. 2 illustrates a schematic 200 of the 5 GHz band 202 used for wireless networks. In one embodiment, the 5 GHz band 202 may include two frequency regions 204, 206 of 5.15 GHz-5.35 GHz and 5.47 GHz-5.825 GHz.

The 5 GHz band 202 may include two DFS regions 208, 210 that may require the communications device 102 to verify that wireless transmission or active channels are not interfering with radars 106 operating on the same frequency. The DFS bands are where scanning is mandatory in the United States and some other countries. As can be seen for 20, 40 and 80 MHz channels, 56%, 67% and 67% of those channels respectively are within the DFS bands and require scanning for use. FIG. 2 also shows that using a contiguous 160 MHz channel may always require scanning.

The 5 GHz band 202 may also be segregating into channel ranges, such as the 20 MHz channel 212, a 40 MHz channel 214, a 80 MHz channel 216, and a 160 MHz channel 218. Each of the channels may also include non-overlapping channels. As shown in FIG. 2, the 20 MHz channel 212 may include 25 non-overlapping channels, the 40 MHz channel 214 may include 12 non-overlapping channels, the 80 MHz channel 216 may include 6 non-overlapping channels, and the 160 MHz channel 218 may include 2 non-overlapping channels.

As noted, APs sold today that operate in the 5 GHz band support scanning, and are configurable to operate in those bands. Client devices will soon have the ability to also scan the DFS bands for use in order to support Peer-to-Peer and Wi-Fi Direct.

As previously noted, in certain instances, it may be desirable to scan not only the active or Wi-Fi channel (the channel, possibly including subchannels, sought to be used to communicate Wi-Fi signals), but also to scan channels adjacent the active channel for any potential or actual interference with radar systems. This could for example be accomplished by having the communications device 102 verify that there are no radars for which the communications device 102 will interfere with over a set transmit power level. This set transmit power level may have any value, such as, for example, down to 30 dB or even 45 dB, or 50 dB or more below the maximum transmit power. The power level may depend on the rigor with which the communications device 102 seeks to avoid interference with radar in not only the active channels but also in the adjacent channels.

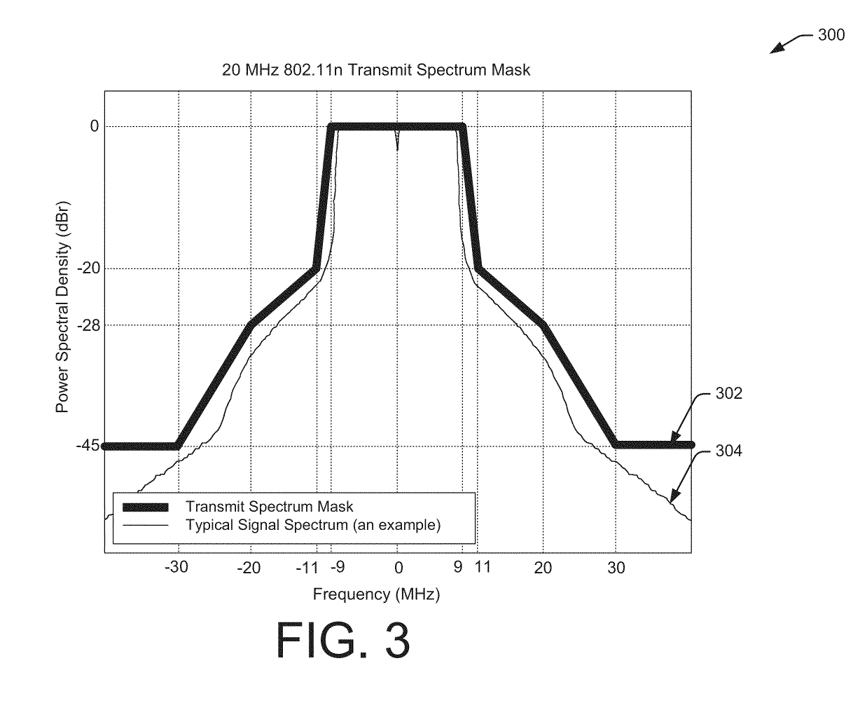

FIG. 3 illustrates a schematic 200 for the transmit power or transmit spectrum mask that may be used for all Wi-Fi devices or the communications device 102 for a 20 MHz transmission per IEEE 802.11n. In addition to an exemplary and actual hardware realization of the transmit waveform relative to the mask or typical signal spectrum 304. Using the actual hardware waveform curve, a requirement of 30 dB would for example require scanning of a total of three channels, the active channel being used/sought to be used for the transmission of Wi-Fi signals, and the two adjacent channels. If the set transmit power level is 50 dB below, then the communications device 102 would have to scan a total of 5 channels including the active channel. This could add a significant overhead to the scan time and potentially increases power consumption and lowers system throughput. It should be noted that a transmit spectrum mask may be generated for other transmission channels (e.g., 40 Mhz, 80 MHz, or 160 Mhz).

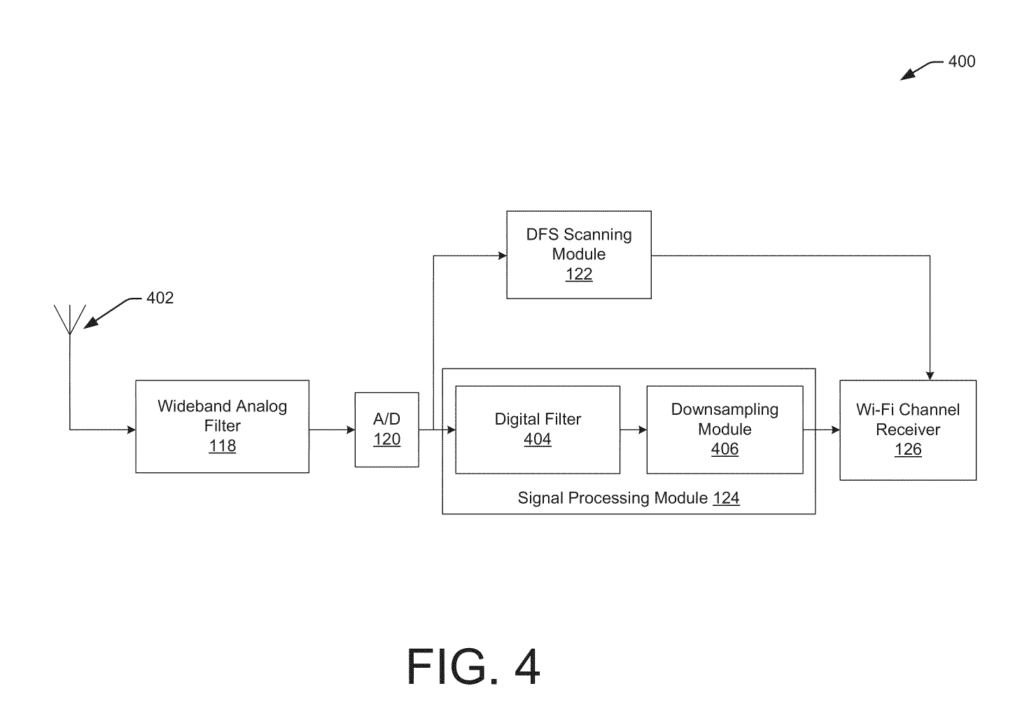

FIG. 4 illustrates a system 400 for detecting radar signals in parallel with processing active and adjacent channel signals of a wireless network. In one embodiment, FIG. 4 shows the basic block diagram of the proposed architecture. This architecture is very well suited for 802.11ac designs that utilize 20, 40, 80 and 160 MHz operational bandwidths since the receiver is capable of receiving and processing various signal bandwidths. For example, as outlined above, an antenna 402 may receive the incoming signals from the wireless device 104 and/or the radar 106. The wideband analog filter 118 may filter the incomings signals to a 20 MHz active channel and an adjacent bandwidth of 50% the communications device 102 (e.g., a 802.11ac device) may use the 40 MHz bandwidth front end (the same one that it already has for normal 40 MHz operation) to sample and filter the incoming signals. The filtered signals may include the bandwidth of the active channel and the bandwidth of the adjacent channels.

The A/D convertor 120 may convert the filtered signals from analog to digital. The A/D sampling rate may be greater than or equal to the adjacent bandwidth to meet the FCC adjacent channel mask. This way, the adjacent channels, in addition to the active channel, may be analyzed for radar signals.

The digital signal may then be split, one branch going to the DFS scanning module 122, the other going to the signal processing module 124. For example, the digital signal may be provided in parallel to the DFS scanning module 122 and the signal processing module 124.

In one embodiment, the signal processing module 124 may include a digital filter 404 and a downsampling module 406. The digital filter 404 may further band limit the signal to include the bandwidth of the active channel. The bandwidth of the adjacent channel may be filtered out or removed. The filtered digital signal may be provided to the receive module 126 (e.g., Wi-Fi channel receiver) or to the downsample module 406 which may downsample the filtered digital to enable additional Wi-Fi processing. The downsampled signal may be provided to the receiver 126. The downsampling module 406 may also provide additional filtering to provide additional band limiting for the 20 MHz channel (e.g., active channel) to meet the receiver 126 requirements of the Wi-Fi signal, or may also include a rate conversion stage and filtering depending on the receiver 126 architecture.

In another embodiment that includes a 160 MHz active channel, where the architecture described above may be modified to support higher sampling rates, depending on the actual hardware design. Currently, for 160MHz, as seen in FIG. 2, scanning of 3 or 5 adjacent channels is not required since that would go beyond the DFS bands. With current DFS and Wi-Fi channel allocations, 160 MHz front end sampling would be much less than that for 20, 40 or 80 MHz from an excess bandwidth or adjacent channel perspective. Thus making the architecture even simpler than the embodiment proposed in FIG. 4.

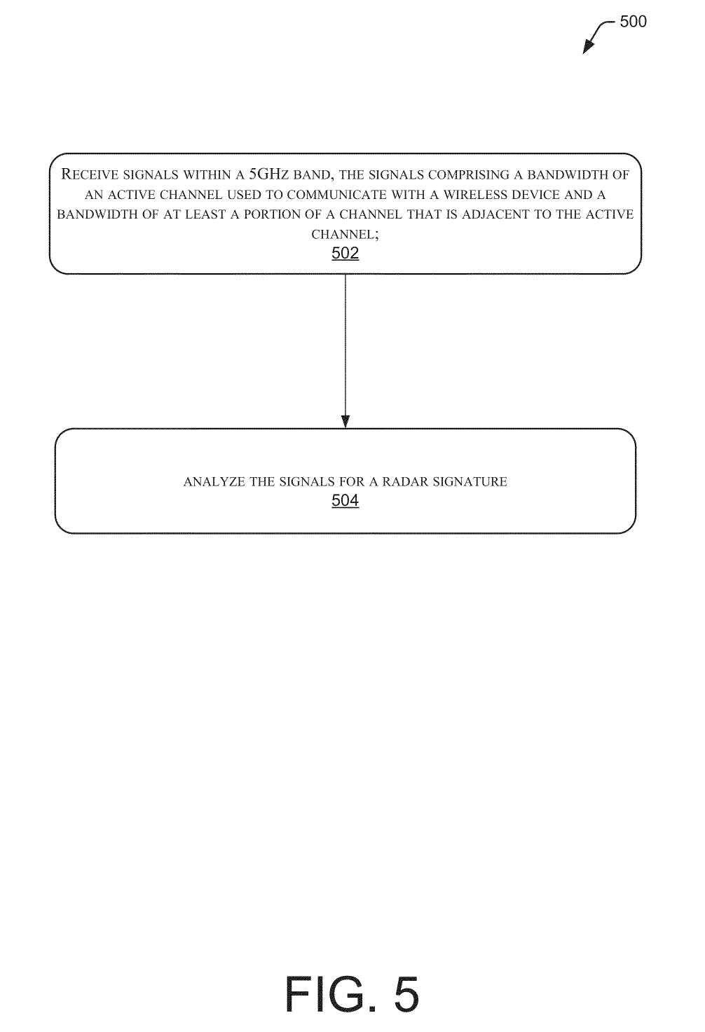

FIG. 5 illustrates a flow diagram for a method 500 for detecting radar signals in parallel with processing active channel signals of a wireless network. As noted above, the bandwidth of the active channels and the bandwidth of channels adjacent to the active channel may be scanned to detect radar signals. Instead of scanning each channel separately, the communications device 102 may scan active channel and adjacent channel bandwidths at the same time using a multi-stage front end receiver 126.

At block 502, the communications device 102 may receive signals within the 5 GHz band that may include an active channel that is being used to communicate information between wireless devices (e.g., communications device 102, wireless device 104). The signals may also include signals in channels that are adjacent to the active channel. The communications device 102 may not tune exclusively to the active channel to enable the collection of the adjacent channel signals. In one embodiment, received signals may include a bandwidth of an active channel that may be used to communicate with the wireless device 104 and a bandwidth of a channel that may be adjacent to the active channel.

At block 504, the communications device 102 may analyze the signals for a radar signature that may indicate a radar source is near the communications device 102. The analysis may include analyzing signals in the DFS portion of the 5 GHz band for the active channel and the one or more adjacent channels. The DFS portion comprising a first range of frequencies from 5.25 GHz to 5.35 Ghz and a second range of frequencies from 5.47 GHz to 5.725 GHz. When the radar signal is detected, the communications device 102 may stop using the active channel and may switch to another channel that does not include radar signals.

In another embodiment, the communications device 102 may process the active channel signals at the same or nearly the same time as DFS scanning module 122 may be scanning for radar signals. For example, the communications device 102 may provide the signals to both the DFS scanning module 122 and the signal processing module 124. The signals may be split after they are received and may be provided in parallel to the DFS scanning module 122 and the signal processing module 124.

The single processing module 124 may filter the provided signals to remove the bandwidth of the adjacent channel while the radar detection module (e.g., DFS scanning module 122) is analyzing the signals for the radar signature. The filtering process passes the bandwidth of the active channel which may be further processed by the communications device 102. In one instance, the signal processing module 124 may also desample the bandwidth of the active channel to enable further processing of the bandwidth of the active channel by other components of the communications device 102.

Embodiments described herein may be implemented using hardware, software, and/or firmware, for example, to perform the methods and/or operations described herein. Certain embodiments described herein may be provided as a tangible machine-readable medium storing machine-executable instructions that, if executed by a machine, cause the machine to perform the methods and/or operations described herein. The tangible machine-readable medium may include, but is not limited to, any type of disk including floppy disks, optical disks, compact disk read-only memories (CD-ROMs), compact disk rewritables (CD-RWs), magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware.

Various features, aspects, and embodiments have been described herein. The features, aspects, and embodiments are susceptible to combination with one another as well as to variation and modification, as will be understood by those having skill in the art. The present disclosure should therefore, be considered to encompass such combinations, variations, and modifications.

The terms and expressions, which have been employed herein, are used as terms of description and not of limitation. In the use of such terms and expressions, there is no intention of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the disclosure have been described in connection with what is presently considered to be the most practical and various embodiments, it is to be understood that the disclosure is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the disclosure, including the best mode, and to enable any person skilled in the art to practice certain embodiments of the disclosure, including making and using any devices or systems and performing any incorporated methods. The patentable scope of certain embodiments of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A device comprising:
a radio to receive signals on an active channel in a 5 GHz band, the signals comprising a wide bandwidth including a bandwidth of the active channel and excess bandwidth adjacent to the active channel; and
a radar scanning engine to scan for a radar signature within the signals.

2. The device of claim 1, wherein the radar scanning engine scans for the radar signature in a Dynamic Frequency Selection (DFS) portion of the 5 GHz band.

3. The device of claim 1, further comprising a signal processing module to process the signals by filtering out signals in the excess bandwidth and to downsample signals active channel signal.

4. The device of claim 3, wherein the radar scanning engine scans for the radar signature while the signal processing module is processing the signals.

5. The device of claim 3, wherein the radar scanning engine scans for the radar signature prior to the processing of the signals by the signal processing module.

6. The device of claim 4, wherein the radar scanning engine scans for the radar signature simultaneously with the processing of the signals by the signal processing module.

7. The device of claim 3, wherein the signal processing module comprises a digital filtering module to filter the signals in the excess bandwidth, the signal processing module further comprising a downsampling module to downsample signals in the active channel.

8. A device comprising:
a radio frequency (RF) receiver to wirelessly receive signals over an active channel in a 5 GHz band, the signals comprising:
a bandwidth of the active channel; and
a bandwidth of one or more channels that are adjacent to the active channel; and
a radar scanning engine to scan for one or more radar signatures within the signals.

9. The device of claim 8, wherein the radar scanning engine is to scan for the radar signature in a Dynamic Frequency Selection (DFS) portion of the 5 GHz band, the DFS portion comprising a first range of frequencies from 5.25 GHz to 5.35 Ghz and a second range of frequencies from 5.47 GHz to 5.725 GHz.

10. The device of claim 8, further comprising a signal processing module to process the signals in parallel with the radar scanning module.

11. The device of claim 10, wherein the signal processing module comprises:
a filter module to remove the bandwidth of one or more channels that are adjacent to the active channel from the signals; and
a downsampling module to downsample the active channel signals provided by the filter module.

12. A method comprising:
receiving, via a radio, signals within a 5 GHz band, the signals comprising a bandwidth of an active channel used to communicate with a wireless device and a bandwidth of a channel that is adjacent to the active channel; and
analyzing, using a radar detection module, the signals for a radar signature.

13. The method of claim 12, further comprising:
providing, in parallel, the signals to the radar detection module and a signal processing module; and
filtering, from the signals provided to the signal processing module, the bandwidth of the channel that is adjacent to the active channel while the radar detection module is analyzing the signals for the radar signature.

14. The method of claim 12, wherein the radar signature comprises a signal within the Dynamic Frequency Selection (DFS) portion of the 5 GHz band.

15. The method of claim 12, further comprising:
providing the signals simultaneously to the radar detection module and a signal processing module; and
filtering, using the signal processing module, the signals to pass the bandwidth of the active channel while the radar detection module is analyzing the signals for the radar signature.

16. The method of claim 15, further comprising downsampling, after the filtering, the bandwidth of the active channel to enable Wi-Fi channel processing of the bandwidth of the active channel.

17. One or more tangible computer-readable storage media comprising computer-executable instructions operable to, when executed by at least one computer processor, enable the at least one computer processor to implement operations comprising:
receiving, via a radio, wireless signals within a 5 GHz band, the wireless signals comprising signals within an active channel used to communicate with a wireless device and signals within a channel that is adjacent to the active channel; and
analyzing, using a radar detection module, the wireless signals for a radar signature.

18. The one or more tangible computer-readable storage media of claim 14, further comprising computer-executable instructions to implement operations for:
providing, in parallel, the wireless signals to the radar detection module and a signal processing module; and
filtering out, from the wireless signals provided to the signal processing module, the signals of the channel that is adjacent to the active channel when the radar detection module is analyzing the wireless signals for the radar signature.

19. The one or more tangible computer-readable storage media of claim 17, further comprising computer-executable instructions to implement operations for:
providing, in parallel, the wireless signals to the radar detection module and a signal processing module; and
filtering out, from the wireless signals provided to the signal processing module, the signals of the channel that is adjacent to the active channel when the radar detection module analyzes the signals for the radar signature.

20. The one or more tangible computer-readable storage media of claim 17, wherein the radar signature comprises a signal with the Dynamic Frequency Selection (DFS) portion of the 5 GHz band.
